(19) United States
(12) Patent Application Publication
(10) Pub. No.: US 2023/0276744 A1
(43) Pub. Date: Sep. 7, 2023

(54) LARGE PLANT BAGGING AND PLANTING SYSTEM AND METHOD OF USE

(71) Applicants: KAREN ELIZABETH TAVAKOLI, Bealeton, VA (US); KAIHAN TAVAKIOLI, Fredericksburg, VA (US)

(72) Inventors: KAREN ELIZABETH TAVAKOLI, Bealeton, VA (US); KAIHAN TAVAKIOLI, Fredericksburg, VA (US)

(21) Appl. No.: 18/113,122

(22) Filed: Feb. 23, 2023

Related U.S. Application Data
(60) Provisional application No. 63/315,661, filed on Mar. 2, 2022.

(51) Int. Cl. A01G 9/08

(52) U.S. Cl. CPC A01G 9/081; A01G 9/083

(57) ABSTRACT

A large plant bagging and planting system that is comprised of a hopper surge bin, a first and second workstation. The workstations are connected at or near the center between them, and each respective workstation has a set of walls, or a circular wall, that tapers inward from a wider top opening to a smaller bottom opening, and there is at least one gate located below the walls or circular wall. There is also at least one gate located below each respective workstation. There is also at least one control arm configured to manipulate and hold a large plant into position within a grow bag while potting media that has been placed in the hopper surge bin, is released from at least one workstation via the at least one gate, in am amount appropriate to fill the grow bad to desired depth.

### CROSS REFERENCE TO RELATED APPLICATION(S)

This application is a Continuation in Part of, and claims the benefit of, U.S. Provisional Application No. 63/315,661 entitled “LARGE PLANT BAGGING AND PLANTING SYSTEM AND METHOD OF USE,” filed on Mar. 2, 2022. The subject matter of this application is hereby incorporated by reference in its entirety.

### TECHNICAL FIELD OF THE INVENTION

The present invention relates to the general field of large plant agriculture, specifically to agricultural machinery and plant tools, and more specifically, to the planting of large plants, such as trees, for continued growth.

### BACKGROUND OF THE INVENTION

Larger plants such as, for example, trees, shrubs, and bushes to be sold or otherwise distributed to locations of interest, often from a plant nursery as the point of order, have been, and often are, field-grown to a size suitable for sale. A tree sapling or seedling, as an example, is planted in the ground, and allowed to grow to a suitable size for sale, then harvested by digging the tree and removing it from the ground along with an amount of surrounding soil to support the tree. These field-grown trees are typically dug up from the ground by a tree spade machine, usually mounted on a truck or tractor that uses hydraulics to force triangular blades into the ground around the tree. The blades sever the tree from much of its root system, so that the tree and a small surrounding plug of earth can be removed.

However, this results in a number of problems. First, when a field-grown tree is harvested and removed from the ground, as much as 90% of the severed root system of the tree can be left behind in the soil. This can result in field-grown trees, or Bag and Burlap (B&B) trees, having a transplant failure rate of about 35%. This is very costly and frustrating.

Further, the field-planted trees absorb nutrients from the surrounding soil, depleting the soil of these vital elements. Accordingly, after trees or other large plants reach maturity and are harvested from the ground, the soil typically needs to be replenished for a period of time. As an example, when field-grown trees are harvested from the ground, the soil requires a three year “off” rotation to give the ground time to replenish itself. That results in three years where the ground cannot be used for anything other than cover crops. This means much ground is going unused at any given time, resulting in a great cost and waste of land.

The current solution to this issue is to plant large plants such as, for example, trees in grow bags. The grow bags are above ground and can be made of various materials. A seedling or sapling and supporting potting media, soil, or other suitable material are placed in the grow bag together. Grow bags have a much lower transplant failure rate for trees (around 2%) of other plants than field-grown or B&B trees because the tree or other plant's entire root system forms within the bag. Further, field-grown trees take about 2.5 times as long to mature as bag-grown trees, meaning bag-grown trees have a much more efficient growth rate than field-grown trees.

Further, because the trees form completely in the above-ground grow bags, growing these trees in these grow bags eliminates the need to rotate any crops. Regarding trees, as nutrients are not being taken from surrounding soil, this would also prevent the three years lost waiting for land to replenish itself before more trees can be grown.

However, planting trees in above-ground grow bags is a very time-consuming and labor-intensive process. Typically, the saplings or seedlings placed into a grow bag can be about six to eight feet tall. Between the large size of the tree, the selected size of the grow bag, and the amount of potting media added, the tree planted in grow bags can be very heavy and difficult to move. It is to be understood that the term “potting media” refers herein to potting media, potting medium, soil, potting soil, or other material as known within the art in which plants can be planted and grown.

There are many different sizes of above-ground grow bags available. The finished weight of a grow bag is determined by a combination of the size of bag selected (typically measured in gallons), the size of the tree to be planted, and the amount and bulk density of the potting media or soil to be placed in the bag. The grow bags, when filled with trees and supporting potting media, can be hundreds of pounds. The bigger the bag, the heavier it will be, requiring more personnel to move the bag.

Currently, the grow-bag planting process typically begins in a central location where the potting media or soil is located in a large pile or mass for ease of access to the potting media, as the potting media is, by far, the heaviest portion involved. A grow bag is presented and filled with a tree and surrounding potting media. The bag is typically partly filled with potting media so that the tree or shrub can be placed upon it. Then the tree is manually placed in the bag and manually held in position by at least one person as the filling of the bag continues and is completed. Typically, the bag is also filled manually.

It can take anywhere from two to six employees to place the plant into the bag and fill it, depending on factors such as the size of the tree, the size of the bag that the tree is to be potted into, and the weight and bulk of potting media involved.

The workers stage themselves around the potting media or soil in groups of two to six per tree. In a two-worker version of the process, one employee is needed to hold the above-ground grow bag open while holding the tree in the correct location within the bag, as another worker shovels the potting media into the above-ground grow bag. When larger above-ground grow bags and plants are involved, additional workers are often required to help in supporting the bag and/or tree.

Once the plant is potted into the grow bag, the filled grow bag is then typically moved away from the pile of potting media to a staging area. An additional crew, typically consisting of about four workers, then lifts and loads the heavy, bagged tree from the staging area onto a trailer and drives the bag to its outdoor grow location where it, along with other planted grow bags, are to be unloaded.

The grow bags are then typically unloaded in the general area where the plants are to be planted. Trees, for example, are often placed and grown in long rows outdoors. These rows can be hundreds of feet long, the grow area covering multiple acres. The bags are then carried by hand into the lines by workers where they will grow and develop before being sold.

This means these heavy bags full of potting media and trees each need to be carried or otherwise transported to their individual grow location. This can involve moving hundreds of pounds over long distances and area, possibly hundreds or even thousands of times.

To move a single grow bag to its growing location, it usually has to be moved a minimum of four times operating at the maximum levels of efficiency, but on average it is moved six times. This process of filling, moving, staging, and placing what can be hundreds or even thousands of individually planted grown plants is usually a long and labor-intensive process, the steps of which require excessive handling over multiple steps to complete. This process often ends up with participation by twelve or more workers to get a single tree properly bagged and transported to its growing site. To plant and place a large number of trees in rows, dozens or more workers may be involved overall.

The inefficiency and labor intensity of this process results in a number of issues, such as a great cost in work, money, and time. Because this process is extremely labor intensive, it also poses serious potential risks to the workers involved. Repeatedly moving this much weight of material over what are often long distances, lifting and lowering what is often many times, greatly increases the risk of the workers involved having accidents or suffering injuries. These often result in time off and worker's comp claims—unwanted by both workers and employers.

Further, the current processes are not only very time consuming but also require extensive amounts of training for the workers. It can take up to a year to property train a worker. For example, workers need to know correct planting depths. Trees planted at incorrect depths, whether field-grown or bag-grown, can fall to thrive, mature at much slower rates, or even die.

In addition, the multiple and continuous movement, plus the numerous times each plant needs to be lifted, set down, and moved before reaching its final growing location, results in additional stress to the newly planted plants, adding risk they will not survive their planting.

In addition, the current processes are time consuming when the time window for planting is typically limited. Trees, for example, often arrive bareroot in the winter. Bareroot trees are seedlings or saplings dug from a field and shipped without surrounding dirt, to be planted into the grow bags. Bareroot trees have only a short window of time, during the winter, when they are in their dormancy period, during which they can be planted without a high mortality rate. If this limited window is missed and trees or shrubs are planted past their dormancy period, their mortality rate can be as high as 100%.

The current processes can best be described as functional yet long, tiring, expensive, highly risky, and generally far from functioning at an optimal level of efficiency. What is needed is a process and apparatus that provides an improved planting solution for large plants, such as trees, particularly when large numbers of large plants are involved, while increasing planting efficiency and reducing labor per plant. Further, what is needed is a process and apparatus that can quicken planting during the limited time window of dormancy while addressing the issues herein.

### SUMMARY

A large grow bag tree bagging and planting system (“system”) and method of use—is shown and described herein. It is to be understood that the term “tree” is used for convenience and herein refers to large plants as known and understood within the art, including, but not limited to, trees, shrubs, and bushes. It is to be further understood that the term “tree” herein also includes large flowering plants capable of growing more than six feet high, such as cannabis.

The grow-bag tree planting system consists, generally, of a hopper surge bin (“hopper”), a respective first workstation and second workstation atop and attached to a holding frame. The hopper is constructed to be filled with potting media and to contain an amount of potting media or soil as the potting media or soil is carried to a planting location.

The first and second workstations are connected at or near the center between them, such that the workstations can both be filled by filling the top of the hopper. A workstation herein has a wider mouth at the top, tapering downward into an opening at the bottom, capable of discharge of the hopper contents. At least the side wall of the first workstation is tapered to funnel the potting media downward, and in other embodiments, the walls are tapered on at least three sides toward the opening. In these embodiments, each workstation is comprised of a first front-tapered wall, first side-tapered wall, and a first rear-tapered wall, to direct the potting media's direction of travel.

The system can be placed on or within a mobile transport apparatus. When one or more trees are to be placed, a suitable amount of potting media is supplied into the hopper. A suitable amount of trees and grow bags are brought along, either in the mobile transport device or separately.

When the mobile transport device reaches or nears a plant placement spot, the grow bag is placed in position. A representative tree is placed in the proper position within the grow bag, typically with the roots in position within the grow bag and suspended at a pre-determined distance above the bottom of the grow bag.

The first robotic arm is capable of holding and manipulating the tree into position. The first robotic arm can be manually operated, or as in this embodiment, include first robotic arm controls and a robotic arm powering apparatus. The first robotic arm and its controls are capable of moving and positioning a tree at a desired location within the grow bag and at a desired height above the bottom of the grow bag.

Generally, a pair of respective representative first upper and lower gates of each workstation, located apart from each other and near the bottom of each workstation, are opened and potting media from the workstation travels downward within the workstation.

In an embodiment, the potting media is funneled by the tapered walls down towards, and out from, a directed spout or discharge at the bottom of the workstation, exiting the directed spout and into the grow bag, positioned beneath the directed spout.

With the grow bag filled and tree planted and secured within, the grow bag can be left there at its growing site, or if needed, moved a short distance to its growing site. With the grow bag now filled and positioned, this is typically where the tree 84 will develop and grow.

In a preferred embodiment, the first upper gate is a rack-and-pinion operated slide gate. This first upper gate can be closed as the hopper is filled. Typically, the upper slide gate is opened during use but is closed during filling of the hopper. Though a rack and pinion apparatus is used in this embodiment, any suitable gate apparatus capable of opening a gate against such pressure can be utilized, including, but not limited to, e.g., a manually operated or motorized system, a hydraulic system, pneumatic system, or alternate gearing system.

The lower gate is also capable of closing the bottom of the first workstation. The lower gate, because it is less likely to have the pressure of the entire load of potting 1o media pressing upon it than the first upper gate, can be a manually operated type gate with manual opening apparatus, but can be any suitable type needed.

To help prevent a compaction clog, the upper and lower gates can be alternatively opened and closed, rather than left open, for gradual release of the potting media to prevent a sudden single drop of potting media through the upper and lower gates and into the first directed spout.

Alternatively, if a compaction clog does occur, each upper gate can be closed, so that gravitational pressure of the potting media from the top of the hopper is against the closed first upper gate instead of against the potting media below the first upper gate. The first lower gate, if it is not open already, can be opened, and any clogs or compacted areas quickly cleared out. A first access cover can also be opened and allow access for quick clearing. The first access cover can be placed wherever appropriate, and in an embodiment, is arranged just above the first upper gate. The arrangement of the first upper gate and first lower gate greatly reduce, if not eliminate, the chances of compaction because an empty space can be created between the two gates, providing the potting media above the upper gate room to expand as it falls.

Further, at least one sight glass can be provided to facilitate visual monitoring of the falling potting media to quickly help spot any compactions or clogs. The at least one sight glass can be provided in number and location as appropriate.

In a further embodiment, an auger media transfer system is provided to mechanically aid in feeding the potting media around a tree. The auger media transfer system is comprised, generally, of an internal auger, an auger spout, and a respective auger motor and auger motor control apparatus. The auger media transfer system is generally attached at the bottom of the workstation. Potting media from the first workstation is directed to, and moved along by, an internal auger. The potting media is pushed through the internal auger and out the first auger spout.

The internal auger in this embodiment is powered by the auger motor, which is controlled by the first auger motor control apparatus. The use of an auger apparatus has a number of advantages. First, the constant movement and breakup of the potting media by the first internal auger will help prevent compactions and clogs. Second, with the internal auger and controls, the rate of fill of a grow bag can be started, stopped, and adjusted by adjusting the speed of the auger motor (usually RPMs). The internal auger can provide speed-controlled and metered feeding of the potting media into the above-ground grow bag. This can provide a discharge rate that can be controlled.

To facilitate the placement of multiple trees, the system is secured on or within the mobile transport apparatus. The mobile transport apparatus can be any device capable of supporting and moving the system to designated grow sites or along rows of grow sites. The system is mounted to the mobile transport apparatus as appropriate to secure it, yet provide room for placement and filling of the grow bags. In another embodiment, the system and mobile transport apparatus can be combined, or even manufactured, as a single-piece planting vehicle with specific purpose.

In a further embodiment, the system is supported by a holding frame. The holding frame is arranged so as to provide secure attachment of the system onto the mobile transport apparatus. In a further embodiment, the holding frame is comprised of a guide for placement upon the mobile transport device and a set of legs.

The holding frame also serves to aid in safe lifting and lowering of the system onto the mobile transport apparatus. The legs assist in mounting the system safely to the mobile transport device and provide stability after mounting by assisting in more evenly distributing the weight of the system and its load. In an embodiment, the guide and legs distribute some of the weight from the sides of the mobile transport device upon which the system is resting on the bed of the mobile transport device.

The workstations are usually provided in at least pairs mounted on a mobile transport device for two reasons. First, in this configuration, trees or other large plants can be planted in grow bags on both sides at once. This is faster and more efficient and provides sufficient growth space between the trees or shrubs. Second, having workstations on both sides balances the weight within the system, which will help prevent tipping.

Further, use of the bilateral workstations in the bed of the mobile transport apparatus not only aids in transport but increases speed and efficiency.

In further embodiments, a fertilizer additive system is provided that is comprised, generally, of a fertilizer hopper, fertilizer internal auger, fertilizer auger motor, and fertilizer auger motor controls. An appropriate amount of fertilizer is fed into each fertilizer hopper, and directed downward to, and moved along by, each first fertilizer internal auger—through each provided aperture in each workstation and into the bottom of each workstation. The fertilizer is pushed through the rotating internal auger toward the first workstation. The fertilizer additive system can be powered by the fertilizer auger motor, which is controlled by the first auger motor control apparatus. The first fertilizer additive system can provide a controlled feed of the fertilizer into the potting media, via the motor controls, leading to an even mix of fertilizer into the potting media.

In another embodiment, a spout extension assists in directing the flow from the auger spout into the grow bag. Each spout extension is comprised of a flexible tubing that can be moved for easier and more efficient feeding of the potting media into each grow bag.

In another embodiment, the mobile transport device is further comprised of an incorporated mobile refill system. The system, mobile transport system, and mobile refill system can be arranged as a single incorporated unit, or separate assembled components. The refill container can be at a fixed location, on a trailer or second mobile vehicle, or be part of a second refill vehicle. In one embodiment, the refill container is at a fixed location. Potting media conveyor tubing extends from the refill container to a location atop or within the hopper. A spout is attached to the end of the potting media conveyor tubing.

In use, a large amount of potting media 82 is placed into the refill container, and the spout and one end of the potting media conveyor tubing is positioned above the hopper. The mobile refill system is activated, and the refill system moves the potting media along the potting media conveyor tube and into the hopper to fill it.

In some embodiments, the system is powered by a refill motor and controlled by refill system controls.

In a further embodiment, though other systems can be used, a pneumatic system is used for moving the potting media. A pneumatic tube is provided from the refill motor and connected to the potting media conveyor tube. A vacuum is created upon activation via the pneumatic tube, moving the potting media along the potting media conveyor tube and into the hopper.

In another embodiment, the length of the hopper on a mobile transport to accommodate alternate amounts of potting media can vary, as well as the size of the mobile transport device to accommodate it.

In yet another embodiment, the size and length of the hopper and number of workstations on a mobile transport can vary, as well as the size of the mobile transport device to accommodate the number of bilateral workstations provided. The hopper can be shortened for smaller workstations, or lengthened to accommodate more workstations if it would be advantageous to increase the planting capacity by increasing the number of workstations per mobile transport device.

In a further embodiment, a pair of additional workstations are added to the hopper. This arrangement doubles the number of workstations of the system on the mobile transport device from two to four. Accordingly, the single hopper can be filled from a single source while supplying the increased number of workstations.

In yet another embodiment, at least one set of apparatus can be added for securing the system to the mobile transport device.

In another embodiment, the process can be automated, with, for example, control of each robotic arm, the first and second auger media transfer systems and their components, the first and second fertilizer additive systems and their components, their respective feed rate and mix ratio, and placement and support of each grow bag, or other components or processes, being achieved by automated means.

In another embodiment, the system includes at least one sensor, such as, e.g., an electric eye sensor, which can coordinate data with the first and/or second robotic arms and the auger media transfer system to determine correct planting depth. The at least one sensor can provide data to monitor the depth of planting media as it fills either grow bag and coordinate with the media transfer system to direct it to start and continue flow, then stop it when the sensor detects the correct depth has been reached. The application of a sensor will help ensure that each above-ground grow bag 80 is filled to the desired level around each tree.

In addition, a hopper surge bin lid can also be provided with the system. The hopper surge bin lid can keep moisture, for example, if it is raining, from getting into the potting media and interfering with its flow.

This invention herein provides an improved planting solution and method for assembling, bagging, planting, and placing trees in their specific grow areas with increased efficiency and labor savings, and in a reduced time.

This invention eliminates the need for workers to individually hand fill grow bags with shovels from a pile of potting media, or to individually move grow bags away from the pile of potting media, or to lift, load, or move the heavy bags to their outdoor grow locations. The invention also reduces the associated stress to large plants of being repeatedly moved before being placed in their grow locations, and helps ensure that trees or other large plants are planted within their limited dormancy time window

### BRIEF DESCRIPTION OF THE DRAWINGS

FIG. 1 is a schematic diagram of an embodiment of the invention.

FIG. 2 is a side view schematic diagram of the embodiment of FIG. 1.

FIG. 3 is a top plan view schematic diagram of the embodiment of FIG. 1.

FIG. 4 is a schematic diagram of the embodiment of FIG. 1, showing the invention in use.

FIG. 5 is a schematic diagram of another embodiment of the invention.

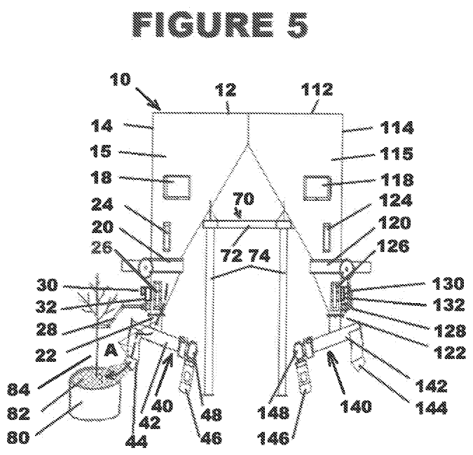

FIG. 6 is a schematic diagram of an additional embodiment of the invention.

FIG. 7 is a side view schematic diagram of the embodiment of FIG. 1, displaying a feature of the invention.

FIG. 8 is a schematic diagram of a further embodiment of the invention in use.

FIG. 9 is a schematic diagram of the embodiment of FIG. 8 in further use.

FIG. 10 is a schematic diagram of an additional embodiment of the invention displaying an additional feature.

FIG. 11 is a schematic diagram of a further possible embodiment of the invention.

FIG. 12 is a schematic diagram of an additional embodiment of the invention, displaying an additional feature.

FIG. 13 is a schematic diagram of an additional embodiment of the invention, displaying an additional feature.

### DETAILED DESCRIPTION OF PREFERRED EMBODIMENTS

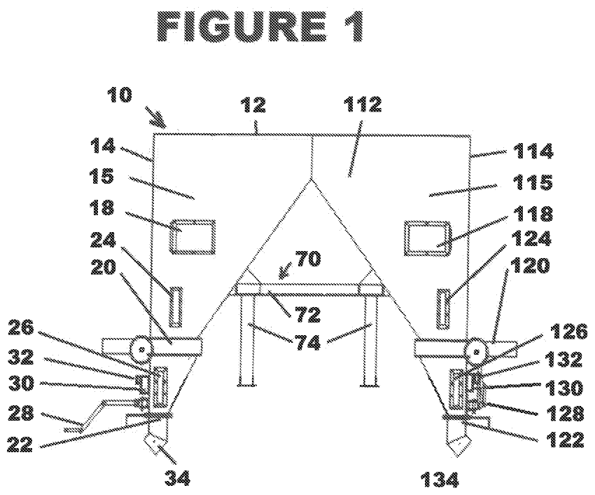

Turning to FIG. 1, a basic embodiment of the invention herein—a large plant bagging and planting system and method of use—is shown and described herein. In some more specific embodiments, described is agricultural machinery for use to assist, such as, for example, the plant nursery industry, in planting large nursery plant stock such as trees in above-ground grow bags. It is to be understood that application of the concept herein can extend beyond trees, and that the term “tree” is used for convenience and herein refers to large plants as known and understood within the art, including, but not limited to, trees, shrubs, and bushes. It is to be further understood that the term “tree” herein also includes large flowering plants capable of growing more than six feet high, such as cannabis.

Other objects, features, and advantages of the invention will become apparent from a consideration of the following detailed description and the accompanying drawings. The following descriptions are made referring to the figures, wherein like reference number refers to like features throughout this description. It is to be understood some features may not be visible in some figures.

The grow-bag tree planting system 10 consists, generally, of a hopper surge bin (“hopper”) 12, a respective first workstation and second workstation 14, 114, atop and attached to a holding frame 70.

The hopper 12 is constructed to be filled with potting media and to contain an amount of potting media or soil as the potting media or soil is carried to a planting location. The hopper 12 can be of any appropriate size, but in one embodiment, has a carrying capacity of approximately five cubic of potting media in each respective workstation 14, 114.

The hopper 12 is also constructed so as to handle the level of moisture that typically comes along with potting media without rusting or otherwise breaking down. The hopper 12 is typically made up of carbon steel, stainless steel, aluminum, or some combination of these.

In this embodiment, the first and second workstations 14, 114 are connected at or near the center between them, such that the workstations 14, 114 can both be filled by filling the top of the hopper 12, though the workstations 14, 114 can be configured such that they are connected but not at the center, or configured such that they are filled separately.

Though there are a respective pair of workstations 14, 114, and though it is to be understood that the second workstation 114 in this embodiment has the same or similar components and method of use of the first workstation 14, this discussion, for focus and clarity, will be in relation to the first workstation 14.

The first workstation 14 herein has a wider mouth at the top, tapering downward into a lower opening at or near the bottom, capable of discharge of the hopper contents. In some preferred embodiments, at least the side wall 16 of the first workstation 14 is tapered to funnel the potting media downward, and in this embodiment, the walls are tapered on at least three sides toward a lower opening. In this embodiment, the workstation is comprised of a first front-tapered wall 15, first side-tapered wall 16, and a first rear-tapered wall 17, to direct the potting media's direction of travel.

In other embodiments each respective workstation 14, 114 is comprised of a circular wall tapering inward from the wider top opening to the lower opening in a funnel type arrangement, or of three sides with at least one side tapering inward from the wider top opening to the lower opening.

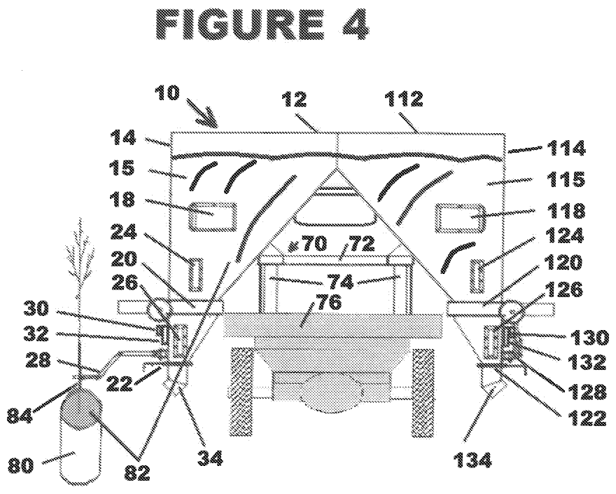

Turning briefly also to FIG. 4, the grow-bag tree planting system (“system”) is provided. The system 10 is placed on or within a mobile transport apparatus 76. The mobile transport apparatus 76 can be any apparatus capable of supporting the system in the art.

When one or more trees are to be placed, a suitable amount of potting media is supplied into the hopper 12. A suitable amount of trees and grow bags are brought along, either in the mobile transport device 76 or separately. This process can involve dozens or hundreds or more trees but will be represented herein with reference to placing a single tree, and with representative tree 84 and grow bag 80.

When the mobile transport device 76 reaches or nears a plant placement spot, the grow bag 80 is placed in position. The tree 84 is placed in the proper position within the grow bag 80, typically with the roots in position within the grow bag 80 and suspended at a pre-determined distance above the bottom of the grow bag 80. This can be done by manually holding the plant in position, or as in this embodiment, by a first controlled robotic arm 28 holding the tree 84 in position.

The first robotic arm 28 is capable of holding and manipulating the tree into position. The first robotic arm 28 can be manually operated, or as in this embodiment, include first robotic arm controls 30 and a robotic arm powering apparatus 32. The first robotic arm 28 and its controls 30 are capable of moving and positioning a tree 84 at a desired location within the grow bag 80 and at a desired height above the bottom of the grow bag 80. It is noted that the robotic arms 28, 128 can be folded when not in use, as shown for the second robotic arm 1.

The first robotic arm controls 30 and powering apparatus 32 can be of any suitable type known in the art. The controls 30 can be, e.g., but are not limited to, a joystick set of levers, a set of buttons and/or switches, a computer and mouse, or touch screen controls. The first robotic arm controls 30 can be present at the apparatus location, as in this embodiment, connected by wires from a separate location, or even controlled remotely with Wi-Fi, Bluetooth, or other signal apparatus. The powering apparatus can include any known in the art, such as, e.g., standard plug-in 110v or 220v, solar apparatus, or battery apparatus.

Generally, a pair of respective first upper and lower gates 20, 22 of the first workstation 14, located apart from each other and near the bottom of the first workstation 14, are opened and potting media 82 from the first workstation 14 travels downward within the first workstation 14.

In this embodiment, the potting media 82 is funneled by the tapered walls 15, 16, 17 down toward, and out from, a first directed spout 34 or discharge (in this embodiment a spout) at the bottom of the first workstation 14, exiting the first directed spout 34, and into the grow bag 80, positioned beneath the first directed spout 34.

When the tree 84 is positioned within the grow bag 80, how the grow bag 80 is filled can vary as appropriate. For example, the tree 84 can be held in position within and above the bottom of the grow bag 80, the first upper and lower gates 20, 22 released, and the grow bag 80 then completely filled, burying the roots of the tree 84 in a single step. In an alternative, the first upper and lower gates 20, 22 can be opened, but only long enough to fill the grow bag 80 to a pre-determined amount above the bottom of the grow bag 80. The first upper and lower gates 20, 22 can be closed and the flow of potting media 82 stopped. The tree 84 can then be placed atop the planting media 82 within the grow bag 84. The first upper and lower gates 20, 22 are re-opened and the filling of the grow bag 80 is resumed to completion.

With the grow bag 80 filled and tree 82 planted and secured within, the grow bag 82 can be left there at its growing site, or If needed, moved a short distance to its growing site. Any further needed steps to set up the tree 84, such as, e.g., adding fertilizers or other chemicals, can be completed. With the grow bag 82 now filled and positioned, this is typically where the tree 84 will develop and grow.

The tree 84 can be sold or transferred but is typically left to grow and develop (except for routine maintenance and the like) for a suitable time, until it is sold or otherwise transferred and permanently planted-typically about two to three years. Because a bagged plant has been assembled and placed on the growing site, the ground soil remains unused and undamaged. In fact, as the underneath of the grow bag 80 tends to provide a dark, warmer place with condensate, it tends to attract creatures capable of creating a beneficial micro-climate for the ground, such as earth worms, Insects, and spiders.

Returning to FIG. 1, in this preferred embodiment, the first upper gate 20 is a rack-and-pinion-operated slide gate. This first upper gate 20 can be closed as the hopper 12 is filled. Typically, the first upper slide gate 20 is opened during use but is closed during filling of the hopper 12. A rack-and-pinion system is provided and used for the upper gate 20 in this embodiment because the weight of the load of potting media 82 above the first upper gate 20 will exert downward pressure against the first upper gate 20, and such an apparatus is capable of opening or closing the first upper gate 20 against the pressure and weight of the potting media 82.

Though a rack and pinion apparatus is used in this embodiment, any suitable gate apparatus capable of opening a gate against such pressure can be utilized, including, but not limited to, e.g., a manually operated or motorized system, a hydraulic system, pneumatic system, or alternate gearing system.

The first lower gate 22 is also capable of closing the bottom of the first workstation 14. The first lower gate 22, because it is less likely to have the pressure of the entire load of potting media 82 pressing upon it than the first upper gate 20, can be a manually operated type gate with manual opening apparatus, but can be any suitable type needed, such as any type described for the first upper gate 20.

When a user moves the potting media 82 into the grow bag 80, because the potting media 82 is funneled inward as well as downward into an ever-narrowing travel area of the first workstation 14 toward the bottom, it can become compacted or clogged and jam, particularly at or near the bottom of the first workstation 14. Such a compaction of the potting media 82 can hamper the flow of potting media 82 or result in a clog of the potting media 82, either slowing or stopping the planting process.

To help prevent a compaction clog, the first upper and lower gates 20, 22 can be alternatively opened and closed, rather than left open, for gradual release of the potting media 82 to prevent a sudden single drop of potting media 82 through the first upper and lower gates 20, 22 and into the first directed spout 34. Because the first tapered walls 15, 16, 17 narrow the path for the potting media 82 as it travels downward, the chances of a compaction clog are greatest at the bottom, in the area below the first upper gate 82 to the first directed spout 34.

Alternatively, if a compaction clog does occur, the first upper gate 20 can be closed, so that gravitational pressure of the potting media 82 from the top of the hopper 12 is against the closed first upper gate 20 instead of against the potting media 82 below the first upper gate 20.

The first lower gate 22, if it is not open already, can be opened, and any clogs or compacted areas quickly cleared out. A first access cover 18 can also be opened and allow access for quick clearing. The first access cover 19 can be placed wherever appropriate, and in this embodiment, is arranged just above the first upper gate 20. The first access cover can additionally provide access as needed for other helpful purposes, such as checking or maintaining the gates 20, 22. The arrangement of the first upper gate 20 and first lower gate 22 greatly reduce, if not eliminate, the chances of compaction because an empty space can be created between the two gates, providing the potting media 82 above the first upper gate 20 room to expand as it falls.

Further, at least one sight glass can be provided to facilitate visual monitoring of the failing potting media 82 to help spot any compactions or clogs quickly. The at least one sight glass can be provided in number and location as appropriate. In this embodiment, there are a respective first upper and lower sight glass 24, 26.

Though in this embodiment, a pair of first gates 20, 22 are used, the gate arrangement can be any suitable one, such as a single gate or additional gates, depending upon such factors as type of potting media used and moisture content of the potting media.

In addition, to enhance material flow and reduce the chances of compactions or clogs, and to quickly clear a compaction or clog should one occur, the tapering walls 15, 16, 17 of the first workstation 14 in this embodiment are arranged to have a steep angle of 65-75 degrees, and more specifically, 70 degrees. Alternatively, the angle can be about 70 degrees; that is, proximate enough to 70 degrees to successfully fulfill the functions described herein.

The second provided workstation 114, though it can have variations in arrangement from the first provided workstation 14, is substantially similar in arrangement and function with the first workstation 14. In this embodiment, for example, the second workstation 114, like the first workstation 14, is comprised of a second front-tapered wall 115, second side-tapered wall, 116 and second rear-tapered wall 117. The second workstation 114 is further comprised of a second access cover 118, second upper slide gate 120 and second lower slide gate 122, a second respective upper and lower slight class 124, 126, and a second directed spout 134. There is also provided a second robotic arm 128, second robotic arm control apparatus 130, and second robotic arm powering apparatus 132.

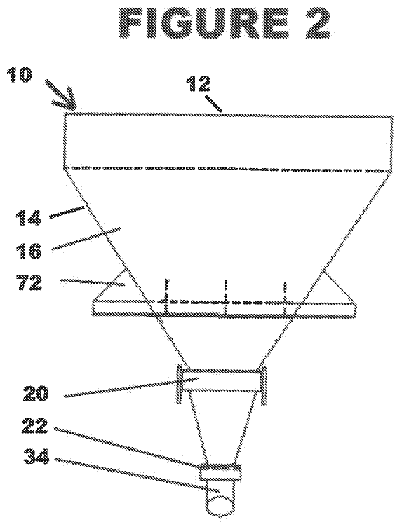

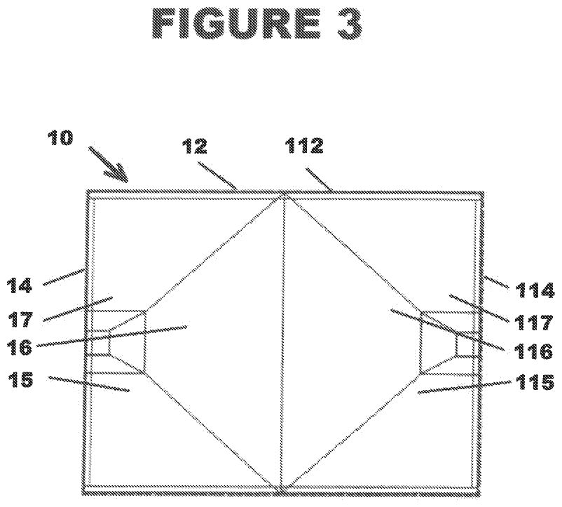

Turning to FIGS. 2-3, other views of the embodiment of FIG. 1 are shown to provide enhanced viewing of the system 10. Turning to FIG. 2, a side view of the embodiment of FIG. 1 is shown. Turning to FIG. 3, a top plan view shows the embodiment of FIG. 1 from above. This view helps show the tapering and flow-directing features of the first and second respective sets of tapered walls 15, 16, 17 and 115, 116, 117.

Turning to Figure, additional apparatus for guiding and moving along the potting media 82 is provided. In this embodiment, a first auger media transfer system 40 is provided to mechanically aid in feeding the potting media around a tree. Though there are a respective pair of first and second auger media transfer systems 40, 140 in this embodiment as before, for focus and clarity, this discussion will be in relation to the first auger media transfer system.

The first auger media transfer system 40 is comprised, generally, of a first internal auger 42, an auger spout 44, and a respective first auger motor 46 and first auger motor control apparatus 48.

The first auger media transfer system 40 is attached at the bottom of the first workstation 14. As indicated by representative arrow A, potting media 82 from the first workstation 14 is directed to, and moved along by, a first internal auger 42. The first internal auger 42 is similar to an agricultural-type auger for moving solid materials along. Such augers generally consist of a shaft and flat helical component wrapped about the shaft within a cylindrical wall. The potting media 82 is pushed through the first internal auger 82 out the first auger spout 44.

The first internal auger 42 in this embodiment is powered by the auger motor 46, which is controlled by the first auger motor control apparatus 48. The first auger motor 46 can be powered by any suitable means in the art, such as fossil fuel, solar, or electric. Further, in other embodiments, other motors may be present. The first motor control apparatus 48 can be comprised of any suitable apparatus known in the art, such as, but not limited to, a joystick set of levers, a set of buttons and/or switches, a computer and mouse, or touch screen controls. The auger control apparatus 48 can be present at the apparatus location, as in this embodiment, connected by wires from a separate location, or even controlled remotely with Wi-Fi, Bluetooth, or other signal apparatus.

The flow of the potting media 82 from the first auger spout 44 into a grow bag 80 is shown. The first auger media transfer system eliminates the need for at least one laborer to hand shovel the potting media 82 into the above-ground grow bag, saving much time and labor.

The use of an auger apparatus has a number of advantages. First, the constant movement and breakup of the potting media 82 by the first internal auger 42 will help prevent compactions and clogs. This can also eliminate the necessity to shovel the potting media into the grow bag 80 and around the tree.

Second, with the first internal auger 42 and controls 48, the rate of fill of a grow bag can be started, stopped, and adjusted by adjusting the speed of the auger motor (usually RPMs). The first internal auger 42 can provide speed-controlled and metered feeding of the potting media 82 into the above-ground grow bag 80. This can provide a discharge rate that can be controlled.

While a single worker or the first robotic arm 28 holds the tree 84 in place, during the planting procedure, a single worker can operate the first internal auger 42 and feed the potting media 82 into the above-ground grow bag 80 in the correct location and support the above-ground grow bag 80 as the potting media 82 continues to be filled around the roots of the tree 84.

Further, labor will be saved by the first robotic arm 28. The robotic arm can hold the tree 82 centered and at the correct height within the grow bag 80 as it is filled with potting media 82 from the first internal auger 42. This saves the labor of at least one worker having to position and hold the tree 84 within the grow bag 80 as the grow bag 80 is filled.

In this embodiment, the second auger media transfer system 140, like the first auger media transfer system 40, is comprised of a second internal auger 142, a second auger spout 144, a second auger motor 140, and a second auger motor control apparatus 148.

Returning to FIG. 4, multiple grow bags are often placed in rows designed and spaced for a vehicle to drive between them for maintenance and the like. The rows are also spaced to allow adequate spacing for the trees to grow. On average, the row the vehicle travels down is ten to twelve feet wide, and the space in between each bag-grown tree or shrub within each row varies depending on factors such as desired finished growth size.

To facilitate this or similar placement of multiple trees, the system 10 is secured on or within the mobile transport apparatus 76. The mobile transport apparatus 76 can be any device capable of supporting and moving the system 10 to designated grow sites or along rows of grow sites. For a few examples, the mobile transport apparatus 76 can be a flatbed trailer, flatbed truck, trailer with rails, or a truck with a bed. The system 10 is mounted to the mobile transport apparatus 76 as appropriate to secure it, yet provide room for placement and filling of the grow bags. In another embodiment, the system 10 and mobile transport apparatus 76 can be combined, or even manufactured, as a single-piece planting vehicle with specific purpose.

In the embodiment of FIG. 4, a truck is shown in use. Also, in this embodiment, the system 10 is supported in this placement by a holding frame 70. The holding frame 70 is arranged so as to provide secure attachment of the system 10 onto the mobile 1s transport apparatus 76. In this embodiment, the holding frame 70 is comprised of a guide 72 for placement upon the truck bed, and a set of legs, represented here as 74, 74′. The system 10 can, alternatively, be supported by a guide or guides. The holding frame 70 also serves to aid in safe lifting and lowering of the system onto the mobile transport apparatus 76. The legs assist in mounting the system 10 safely to the mobile transport device 76 and provide stability after mounting, by assisting in more evenly distributing the weight of the system 10 and its load. In this embodiment, for example, the guide 72 and legs distribute some of the weight from the sides of the truck 76 upon which the system 10 is resting on the bed of the truck. In this preferred embodiment of the system 10, at least a pair of workstations 14, 114 are provided, each extending off the respective sides of the bed of the truck 76 and secured to the truck 76 by the holding frame 70.

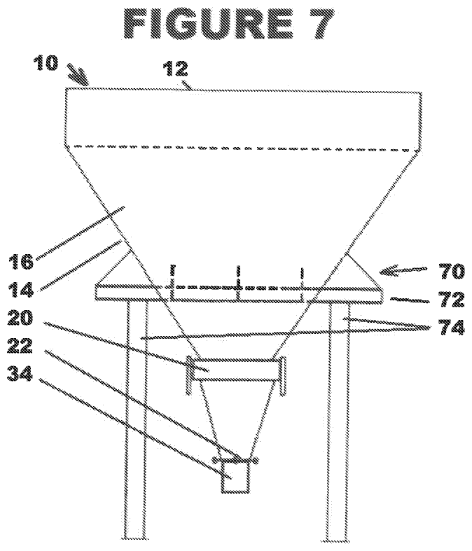

Turning to FIG. 7, a side view of an embodiment of the system 10 is shown. The holding frame 70 is shown with a set of longer legs 74, 74′ for use in distributing the load in a flatbed trailer or truck.

As can be seen in various figures, the workstations 14, 114 are usually provided in at least pairs mounted on the bed or trailer for two reasons. First, in this configuration, trees or shrubs can be planted in grow bags on both sides at once. This is faster and more efficient and provides sufficient growth space between the trees or shrubs. Second, a single system filled with potting media will weigh a great deal—up to thousands of pounds. Having workstations on both sides balances the weight within the system 10, which will help prevent tipping.

Use of the bilateral workstations 14, 114 in the bed of the mobile transport apparatus 76 not only aids in transport but increases speed and efficiency. With bilateral workstations 14, 114 provided, several or possibly as few as two employees—one working off each side of the truck or trailer—can easily plant multiple trees in above-ground grow bags, which normally requires up to eight people to accomplish. Further, since the trees are placed at their grow sites where they will develop before they are sold, the additional four worker crew members to move said trees are also no longer required. Accordingly, what would typically be a twelve-worker operation can be reduced greatly, possibly down to a two-worker operation.

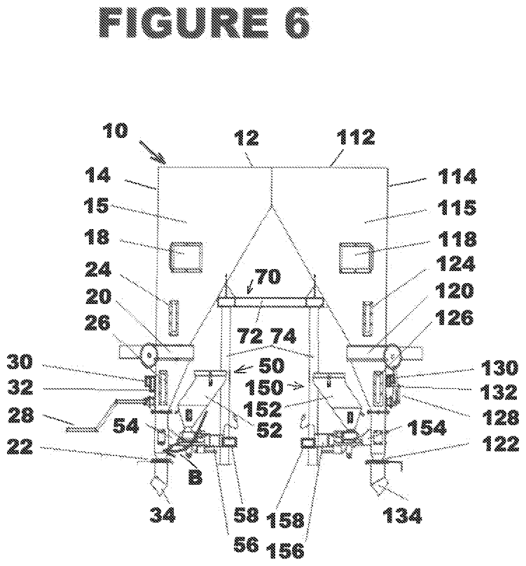

Turning to FIG. 6, it is often advantageous to add fertilizers, beneficial chemicals, or other additives (“fertilizer”) at the time of planting and placement. Though a pair of respective first and second fertilizer additive apparatus 50, 150 are provided, for focus and clarity, this discussion will be in relation to the first fertilizer additive apparatus 50.

The first fertilizer additive system 50 is comprised, generally, of a first fertilizer hopper 52, first fertilizer internal auger 54, first fertilizer auger motor 56, and first fertilizer auger motor controls 58. The first fertilizer additive system 50 is attached at the bottom portion of the first workstation 14 at an appropriate location; in this embodiment, it is between the first upper and first lower gates 20, 22.

As indicated by representative arrow B, an appropriate amount of fertilizer is fed into the first fertilizer hopper 52, and directed downward to, and moved along by, the first fertilizer internal auger 54—through a provided aperture in the first workstation 14 and into the bottom of the first workstation 14. The first fertilizer internal auger 54 is similar to an agricultural-type auger for moving solid materials along. The fertilizer is pushed through the rotating first internal auger 54 toward the first workstation 14.

The first fertilizer additive system 50 in this embodiment is powered by the first fertilizer auger motor 56, which is controlled by the first auger motor control apparatus 58. The first fertilizer auger motor 56 can be powered by any suitable means in the art, such as fossil fuel, solar, or electric. Further, in other embodiments, other motors may be present.

The first fertilizer auger motor controls 58 can be comprised of any suitable apparatus known in the art, such as, but not limited to, a joystick set of levers, a set of buttons and/or switches, a computer and mouse, or touch screen controls. The first fertilizer auger control apparatus 58 can be present at the apparatus location, as in this embodiment, connected by wires from a separate location, or even controlled remotely with Wi-Fi, Bluetooth, or other signal apparatus.

The first fertilizer additive system 50 can provide a controlled feed of the fertilizer into the potting media 82, via the motor controls 58, leading to an even mix of fertilizer into the potting media. The first fertilizer additive system 50 can reduce or eliminate the need for manual measuring, monitoring, and hand feeding fertilizer into the potting soil, saving much time and labor. If the fertilizer is a “top dress” fertilizer, the fertilizer auger motor 56 can be left off, then turned on at or near the end of filling the grow bag 82, to provide a layer of fertilizer at or near the potting media surface within the grow bag 80.

Additionally, the second fertilizer additive system 150 is comprised of a second fertilizer hopper 152, a second fertilizer internal auger 154, a second fertilizer auger motor 156, and a second fertilizer auger motor controls 158.

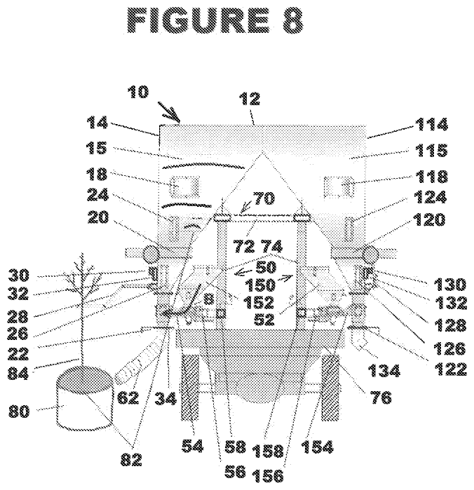

Turning to FIG. 8, another embodiment of the system 10 is shown, having the respective first and second fertilizer additive systems 50, 150. Here, both potting media flow A and fertilizer flow B are shown. Here also is shown a first spout extension 62 in use. The first spout extension 62 assists in directing the flow from the auger spout 44 into the grow bag 80. The first spout extension 62 is comprised of a flexible tubing that can be moved for easier and more efficient feeding of the potting media 82 into the grow bag 80.

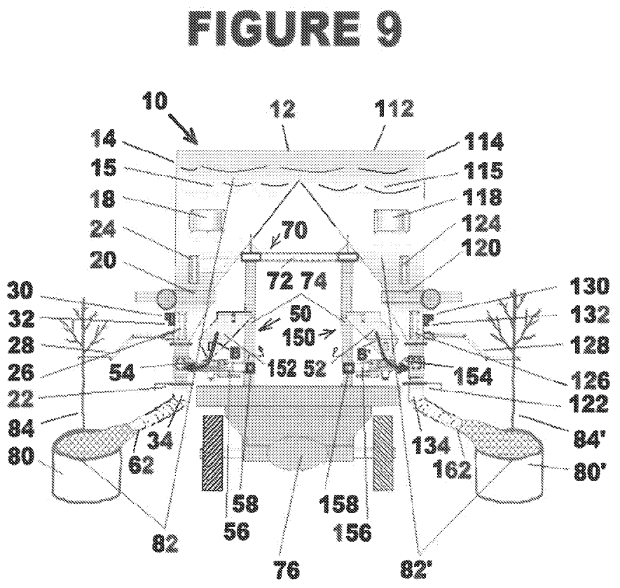

Turning to FIG. 9, an embodiment showing both respective workstations 14, 114 in use on both sides, with arrows B′, B′ Indicating the respective directions of fertilizer flow. Further, respective potting media 82, 82′ flows from respective first and second spout extension 62, 162 into the respective grow bags 80 with respective trees 84, 84′.

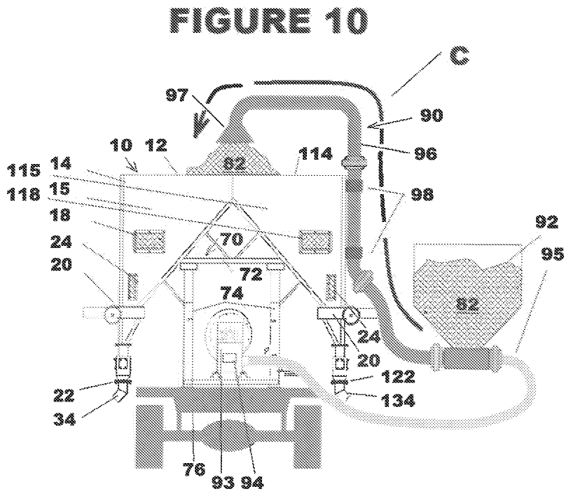

Turning to FIG. 10, in another embodiment, a mobile refill system 90 is provided. The typical way in the art to fill something like the hopper 12 would be to obtain a scooping apparatus like a bobcat and fill the hopper 12 a scoop at a time. Needless to say, this can be a slow process that encumbers the planting process.

Herein, the mobile transport device 76 is further comprised of an incorporated mobile refill system 90. The system 10, mobile transport system 76, and mobile refill system 90 can be arranged as a single incorporated unit, or separate assembled components. In this embodiment, a refill container 92 is provided. The refill container 92 can be at a fixed location, on a trailer or second mobile vehicle, or be part of a second refill vehicle. In this embodiment, the refill container 92 is shown at a fixed location. Potting media conveyor tubing 96 extends from the refill container 92 to a location, in this embodiment, atop the hopper 12. A spout 97 is attached to the end of the potting media conveyor tubing 96.

In use, and as shown by arrow C, a large amount of potting media 82 is placed into the refill container 92, and the spout 97 and one end of the potting media conveyor tubing 96 is positioned above the hopper 12. The mobile refill system 90 is activated and the refill system 90 moves the potting media 82 along the potting media conveyor tube 96 and into the hopper 12 to fill it.

The mobile refill system 90 can move the potting media 82 by any suitable means in the art, such as, e.g., a conveyor, agricultural auger, or pneumatic conveying system. The system can be activated and powered by any known and acceptable means in the art.

In this embodiment, for example, the system is powered by a refill motor 93 and controlled by refill system controls 94. Also in this embodiment, a pneumatic system is shown for moving the potting media 82. A pneumatic tube 95 is provided from the refill motor 93 and connected to the potting media conveyor tube 96. A vacuum is created upon activation via the pneumatic tube 95, moving the potting media 82 along the potting media conveyor tube 96 and into the hopper 12. The pneumatic system is somewhat analogous to the pneumatic system commonly used by banks at their drive-thru facilities.

The mobile refill system 90 can be secured to the system 10 by suitable means, including herein a set of clamps 98. The attached mobile refill system 90 can be maneuvered into a position when in use, and another out of the way position when not in use.

The refill motor 93 can be powered by any suitable means in the art, such as fossil fuel, solar, or electric. One or more additional motors may be present as well.

The refill control apparatus 94 can be comprised of any suitable apparatus known in the art, such as, but not limited to, a joystick set of levers, a set of buttons and/or switches, a computer and mouse, or touch screen controls. The refill control apparatus 94 can be present at the apparatus location, as in this embodiment, connected by wires from a separate location, or even controlled remotely with Wi-Fi, Bluetooth, or other signal apparatus.

The mobile refill apparatus 90 adds to speed and efficiency by providing an apparatus for enabling the system 10 to be at use in the field longer, and with fewer interruptions. Currently, many trips back and forth to a central pile of potting media are necessary to transport the filled bags with potting media 82 from the pile to the grow bags as the grow bags are being placed. Though the system 10 is a great improvement over this, the system would still need to be transported back and forth to the pile of potting media for refilling as work progresses.

With the mobile refilling system 10, the hopper 10 can, in one embodiment, be quickly filled from the refill container 92 rather than being loaded by bobcat or other typical means. This means that the system 10 is offline for less time to be refilled, increasing efficiency and speed. If the refill container 92 is placed on a secondary vehicle, the secondary vehicle can approach the mobile transport device 76, and with the mobile refill system 90, the hopper 12 can be loaded directly from the refill container 92. This would be somewhat analogous to refueling a first jet from a second refueling jet while in flight. In this embodiment, the system 10 could continue staying in use with no need to take it offline for refilling. Besides increasing the speed and efficiency of the process, it also increases safety by reducing the chances for tipping or other mishaps while the mobile transport device 76 moves back and forth for refilling. There is also less wear and rutting of the ground between the bag planting area and pile of potting media 82.

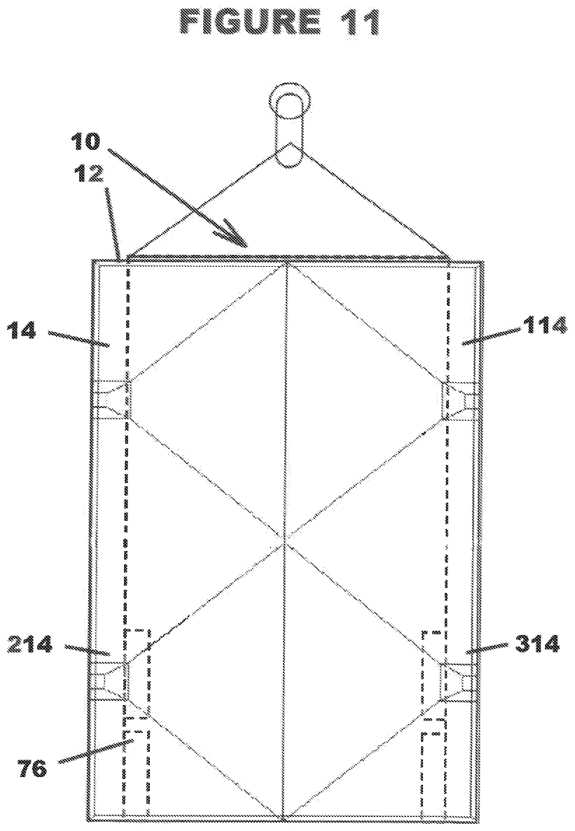

Turning to FIG. 11, the size and length of the hopper 12 and number of workstations 14, 114 on a mobile transport 76 can vary, as well as the size of the mobile transport device 76 to accommodate the number of bilateral workstations provided. The hopper 12 can be shortened for smaller workstations, or lengthened, along with the mobile device 76 (which in this embodiment is a trailer) to accommodate more workstations if it would be advantageous to increase the planting capacity by increasing the number of workstations per mobile transport device 76.

In this embodiment, for example, a pair of additional respective third and fourth workstations 214, 314 have been added to the hopper 12. This arrangement doubles the number of workstations 14, 114, 214, 314 of the system 10 on the mobile transport device 76 from two to four. Accordingly, the single hopper 12 can be filled from a single source while supplying the increased number of workstations 14, 114, 214, 314. This or similar alterations of the hopper to allow more workstations results in a greater capacity of a single system 10 to bag and place more trees simultaneously.

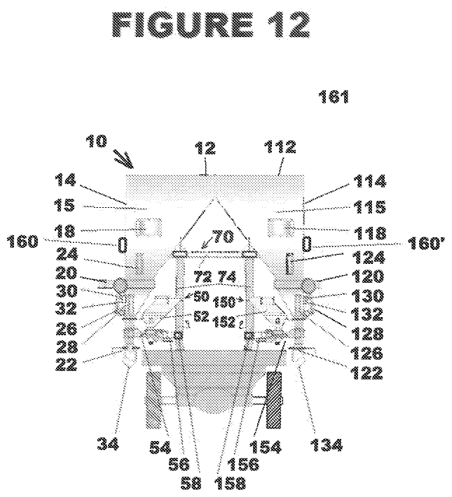

Turning to FIG. 12, at least one set of apparatus can be added for securing the system 10 to the mobile transport device 76. In this embodiment, a set of securing apparatus 160, 160′ are welded or otherwise secured to both the system 10 and the mobile transport device 76. The securing apparatus 160, 160′ can be comprised of a hook, loop, D-ring, or other appropriate securing apparatus. At least one strap, chain, wire, rope, line, or other appropriate securing means can then be attached to the securing apparatus 160, 160′ and to the mobile transport device 76, then tightened to secure the system 10.

In another embodiment, the process can be automated, with control of the first and second robotic arms 28, 128, the first and second auger media transfer systems 40, 140 and their components, the first and second fertilizer additive systems 50, 150 and their components, their respective feed rate and mix ratio, and placement and support of each grow bag 80, and other components or processes, being achieved by automated means. An algorithm can be created, and the mechanical components can be linked to a computer or computers, to control the process. The process can be machine-controlled by AI, and if desired, machine learning can be added to a program for continuous improvement. Alternatively, the process can be controlled by one or more users with a computer, i.e., in a control station.

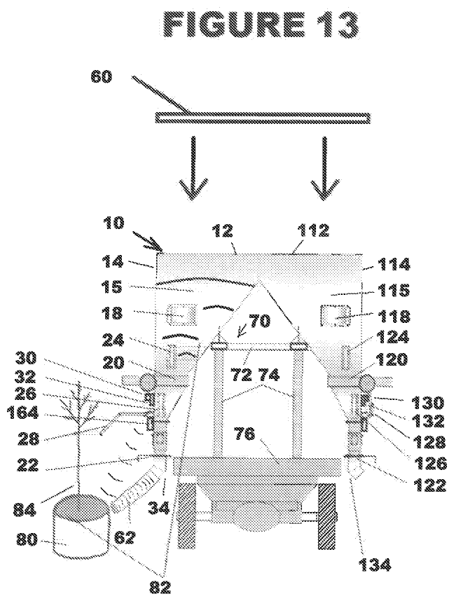

Turning to FIG. 13, in another embodiment, the system 10 includes at least one sensor 164, such as, e.g., an electric eye sensor, which can coordinate data with the first and/or second robotic arms 28, 128 and the auger media transfer system 40 to determine correct planting depth. The at least one sensor 164 can provide data to monitor the depth of planting media 82 as it fills either grow bag 80, 80′ and coordinate with the media transfer system 40 to direct it to start and continue flow, then stop it when the sensor detects the correct depth has been reached. Use of the sensor 164 in this way will greatly increase the consistency in planting trees in above-ground grow bags by greatly reducing or eliminating the variability and errors that come from multiple different workers and their varying skills and abilities when planting.

The application of a sensor 164 will help ensure that each above-ground grow bag 80 is filled to the desired level around each tree 84. This will reduce the variability in planting depths which, when not correct, can result in total failure of the tree. This can also increase the consistency in the growth and cultivation of each tree 84 while simultaneously reducing the amount of wasted potting media 82 due to spilling or mishandling.

Thus, a number of issues can be avoided. For example, trees planted at incorrect depths may have oxygen-deprived roots resulting in root system deformity and inability to adequately transport nutrients. This can cause slowed growth during production or death of the tree. Due to the chronic stress from being planted at an incorrect depth, trees are also more susceptible to disease and infestation over time, which can also lead to subsequent death.

In addition, a hopper surge bin lid 60 can also be provided with the system 10. The hopper surge bin lid 60 can protect the interior of the system 10 when not in use, or when the system 10, 10′ is in use. The hopper surge bin lid 60 can keep moisture, for example, if it is raining, from getting into the potting media 82 and interfering with its flow.

It is noted that the overall system 10 design is scalable. Both the size of the hopper 12 and number of incorporated workstations can be adjusted to fit any size of pickup truck, flatbed truck, or pull-behind trailer system with some minor adjustments.

This invention provides an improved planting solution and method for assembling, bagging, planting, and placing trees in their specific grow areas with increased efficiency and labor savings, and in a reduced time. This invention eliminates the need for workers to individually hand fill grow bags with shovels from a pile of potting media.

This invention also eliminates the need for workers to individually move grow bags away from the pile of potting media to a staging area, lift and load the heavy, bagged trees, move the bags to their outdoor grow locations, unload the bags, and carry the bags to their individual grow locations. Overall, this system can reduce the labor of planting a tree 84 in a grow bag 80 and placing it at the growing spot from multiple workers, often up to twelve workers, down to two workers, or even possibly a single worker.

The invention, by reducing labor to move heavy grow bags about, frees workers for other tasks and reduces risks to workers of accidents, injuries, or other medical issues. Further, the training required for workers (e.g., guessing correct fill depths, etc.) can be greatly reduced.

The invention also reduces the associated stress to large plants of being repeatedly moved before being placed in their grow locations.

Further, the invention helps ensure that trees are planted within their limited time window of dormancy, reducing the mortality risk to the trees.

It is to be understood that while certain forms of the present invention have been illustrated and described herein, the expression of these individual embodiments is for illustrative purposes and should not be seen as a limitation upon the scope of the invention. It is to be further understood that the invention is not to be limited to the specific forms or arrangements of parts described and shown.

1. A method of planting a large plant within an above-ground grow bag, comprising the steps of:
providing a large plant bagging and planting system; comprising;
a hopper surge bin, and
at least a first workstation and a second workstation,
wherein each respective workstation is configured to discharge the hopper contents from the bottom of each respective workstation,
wherein each workstation is comprised of either
four walls with at least one wall tapering inward from a wider top opening to a smaller bottom opening,
three walls with at least one side tapering inward from a wider top opening to a smaller bottom opening, or
a circular wall tapering inward from a wider top opening to a smaller bottom opening,
and at least one gate located below either the three walls, the four walls, or the circular wall.

2. The method of planting a large plant within an above-ground grow bag of claim 1, further comprising the step of:
providing at least one control arm configured to manipulate and hold a large plant into position,
wherein the at least one control arm is either
a manually controlled arm, or
a robotic arm,
and wherein if the control arm is a robotic arm, the robotic arm is further comprised of arm controls and a powering apparatus,
and wherein the robotic arm controls are either
present at the apparatus location,
connected by wires from a separate location,
or controlled remotely.

3. The method of planting a large plant within an above-ground grow bag of claim 1, wherein the at least a first and second workstation are connected at or near the center between them,
and wherein the respective workstations are configured to be filled by filling the top of the hopper,
and further comprising the step of providing a holding frame located below the at least a first workstation and a second workstation.

4. The method of planting a large plant within an above-ground grow bag of claim 1, wherein the at least one gate is comprised of an upper gate and a lower gate,
and wherein the upper and lower gate are each
a rack-and-pinion-operated slide gate,
a manually operated gate,
a motorized gate,
a hydraulic system gate,
a pneumatic gate,
or any combination thereof.

5. The method of planting a large plant within an above-ground grow bag of claim 4, further comprising the step of:
providing a first access cover located above the upper gate and providing a second access cover located below the upper gate.

6. The method of planting a large plant within an above-ground grow bag of claim 4, further comprising the step of:
providing at least one upper sight glass above the upper gate and providing a lower sight glass above the lower gate.

7. The method of planting a large plant within an above-ground grow bag of claim 1, further comprising the step of:
providing a directed spout below the at least one gate configured to direct potting media toward a grow bag.

8. The method of planting a large plant within an above-ground grow bag of claim 1, further comprising the step of:
providing at least one auger media transfer system located below the at least one gate,
and wherein the auger media transfer system is further comprised of an internal auger, an auger spout, an auger motor, and control apparatus that controls the auger motor.

9. The method of planting a large plant within an above-ground grow bag of claim 8, wherein the auger media transfer system is configured to provide a controllable discharge rate of potting media.

10. The method of planting a large plant within an above-ground grow bag of claim 1, further comprising the step of either:
providing a mobile transport apparatus,
wherein the at least one workstation is secured to the mobile transport apparatus,
and wherein the mobile transport device is a pickup truck, flatbed trailer, flatbed truck, trailer with rails, or a truck with a bed,
and the system is further comprised of either
a holding frame, or
at least one guide,
wherein the holding frame or at least one guide is configured to secure the at least one workstation onto the mobile transport apparatus,
or,
providing an integrated planting vehicle comprised of the at least one workstation and mobile transport apparatus.

11. The method of planting a large plant within an above-ground grow bag of claim 1, wherein the at least one workstation is comprised of at least a pair of bilateral workstations, configured to dispense potting media from both sides of either a mobile transport apparatus or an integrated planting vehicle.

12. The method of planting a large plant within an above-ground grow bag of claim 1, further comprising the step of:
providing at least one fertilizer additive system,
wherein each fertilizer additive system is further comprised of
a fertilizer hopper,
a fertilizer internal auger,
and a fertilizer spout for discharging potting media,
and wherein each fertilizer additive system is located below either the three walls, the four walls, or the circular wall.

13. The method of planting a large plant within an above-ground grow bag of claim 1, further comprising the steps of:
providing
at least one robotic arm,
at least one auger media transfer system,
at least one fertilizer additive systems,
or any combination of these,
and providing at least one automating apparatus configured to automate
the at least one robotic arm,
the at least one auger media transfer system,
the fertilizer additive systems,
or any combination of these.

14. The method of planting a large plant within an above-ground grow bag of claim 1, further comprising the steps of:
providing
at least one robotic arm,
at least one auger media transfer system,
at least one fertilizer additive systems,
or any combination of these,
and providing at least one computer linked to
the at least one robotic arm,
auger media transfer system,
fertilizer additive system,
or a combination of these,
and wherein the automating apparatus is controlled by an algorithm, artificial intelligence, machine learning, or a combination of these.

15. The method of planting a large plant within an above-ground grow bag of claim 1, further comprising the steps of:
providing
at least one robotic arm,
at least one auger media transfer system,
or both,
and providing at least one sensor configured to coordinate data with
the at least one robotic arm,
the auger media transfer system,
or both,
to inform the system when to start potting media flow, and to stop potting media flow once a determined depth has been reached.

16. The method of planting a large plant within an above-ground grow bag of claim 1, further comprising the steps of:
providing at least one above-ground grow bag
providing at least one robotic arm,
positioning and holding a large plant in place in a specific position within the grow bag with the at least one robotic arm, and
feeding potting media from a workstation into the above-ground grow bag, to a determined depth, such that a portion of the large plant is beneath the depth of the potting media.

17. A large plant bagging and planting system, comprising:
a hopper surge bin,
at least a first workstation and a second workstation,
wherein each respective workstation is configured to discharge the hopper contents from the bottom of each respective workstation,
wherein each workstation is comprised of either
four walls with at least one wall tapering inward from a wider top opening to a smaller bottom opening,
three walls with at least one side tapering inward from a wider top opening to a smaller bottom opening, or
a circular wall tapering inward from a wider top opening to a smaller bottom opening,
and at least one gate located below either the four walls, the three walls, or the circular wall.

18. The large plant bagging and planting system of claim 17, wherein the system is further comprised of
at least one control arm configured to manipulate and hold a large plant into position,
wherein the at least one control arm is either
a manually controlled arm, or
a robotic arm,
and wherein if the control arm is a robotic arm, the robotic arm is further comprised of arm controls and a powering apparatus,
and wherein the robotic arm controls are either
present at the apparatus location,
connected by wires from a separate location,
or controlled remotely.

19. The large plant bagging and planting system of claim 17, wherein the at least a first and second workstation are connected at or near the center between them,
and wherein the respective workstations are configured to be filled by filling the top of the hopper surge bin,
and further comprising the step of providing a holding frame located below the at least first workstation and second workstation.

20. A large plant bagging and planting system, comprising:
a hopper surge bin,
at least a first workstation and a second workstation,
wherein each respective workstation is configured to discharge the hopper contents from the bottom of each respective workstation,
wherein each workstation is comprised of either
four walls with at least one wall tapering inward from a wider top opening to a smaller bottom opening,
three walls with at least one side tapering inward from a wider top opening to a smaller bottom opening, or
a circular wall tapering inward from a wider top opening to a smaller bottom opening,
and at least one gate located below either the four walls, the three walls, or the circular wall,
and the system is further comprised of a mobile refill system
wherein the mobile refill system is further comprised of
a refill container.
potting media conveyor tubing extending from the refill container to a location atop or within the hopper surge bin,
and apparatus configured to move potting media through the potting media conveyor tubing.
